(19) United States
(12) Patent Application Publication
(10) Pub. No.: US 2002/0177669 A1
(43) Pub. Date: Nov. 28, 2002

(54) Protective adhesive films

(76) Inventors: Isabelle Jenny, Rouen (FR); Richard Korane, Centerville, OH (US); Catherine Lefebvre, Mont-Saint-Aignan (FR); Christelle Dacharry, Hyeres (FR)

Correspondence Address: Ira J. Schultz, DENNISON, SCHULTZ & DOUGHERTY, Suite 612, 1745 Jefferson Davis Highway, Arlington, VA, 22202, US

(21) Appl. No.: 10/150,488

(22) Filed: May 20, 2002

(30) Foreign Application Priority Data
May 22, 2001 (FR) 01 06706

(51) Int. Cl. C08F 36/00

(52) U.S. Cl. 525/332.8; 524/426

(57) ABSTRACT

The present invention relates to a protective film comprising an adhesive composition comprising:

(A) at least one compound selected from a low density free-radical polyethylene; a copolymer of ethylene and a C₃-C₈ olefinic monomer; an ethylene/propylene copolymer; an ethylene/propylene/diene; an ethylene/vinyl acetate copolymer; a copolymer of ethylene and an acrylic derivative; a styrene/ethylene-butylene/styrene copolymer; a styrene/butadiene/styrene copolymer; a styrene/isoprene/styrene copolymer; an ethylene/styrene copolymer; a tackifying resin; and mixtures thereof; and

(B) a block copolymer containing at least two poly(monovinylic aromatic hydrocarbon) blocks and at least one hydrogenated poly(conjugated diene) block; and/or a polybut-1-ene.

The invention relates to a pressure-sensitive adhesive film obtained from a specific adhesive composition.

The invention is applied especially in the field of the protection of surfaces such as plastic sheets (PMMA, PC, PVC, etc.), precoated surfaces (prelacquered surfaces, co-laminated surfaces, etc.), laminated materials and furniture, plastic profiles, bare metals (aluminum, stainless steel, etc.) and car surfaces, including bodywork in particular.

Films referred to as “pressure-sensitive” are intended for the temporary protection of surfaces; the adhesive strength generally sought in this application is such that the film has a sufficient adhesion to the surface to be protected and can be removed easily and without leaving a trace of adhesive.

There currently exist different categories of surface protecting films. In particular, there may be mentioned corona-treated polyolefin films, films consisting of a polyolefin coated with an acrylic adhesive (in the solvent or aqueous phase), films consisting of a polyolefin coated with a rubber adhesive, and films obtained by the co-extrusion of a polyolefin-based support layer and a specific adhesive layer.

However, all these films have disadvantages which are such that it is not possible satisfactorily to comply with the “specifications sheet” referred to above:

corona-treated polyolefin films have fluctuating adhesive characteristics which are difficult to control, and can only be applied hot; in addition, once separated, they no longer adhere to the surface they protect;

films consisting of a polyolefin coated with an acrylic adhesive do not have an appropriate adhesive behavior for the temporary protection of smooth plastics and aluminum; the quality of the glue and/or coating can create marks on PVC, aluminum and car surfaces after application or after temperature tests. Furthermore, these films can present problems of “surface pollution”, invisible to the naked eye, after deprotection. Finally, the cost of these films is high because their production requires two steps (co-extrusion of the film+coating of the glue) and, if the adhesive used is in the solvent phase, it is essential to provide a solvent recovery and/or depollution device to comply with the regulatory and environmental constraints;

films consisting of a polyolefin coated with a natural rubber adhesive are not stable to UV if the application requires the use of a transparent film. Their cost is again high for the same reasons as those indicated above;

protective films obtained by the coextrusion of a polyolefin-based support layer and a specific adhesive layer, for example based on EVA or PE, and a tackifying resin, are more particularly intended for protecting plastic surfaces and, more generally, smooth and glossy surfaces.

The present invention proposes to overcome these disadvantages and relates to adhesive compositions which make it possible to obtain adhesive films for temporary surface protection which are compatible with all types of surfaces, particularly precoated surfaces such as prelacquered surfaces (especially those treated with polyester and PVDF lacquers) and co-laminated surfaces, plastic profiles and furniture, laminated materials, bare metals (aluminum, stainless steel, etc.) and car surfaces, including bodywork in particular.

Thus, according to a first feature, the invention relates to a protective adhesive film comprising a support layer and an adhesive layer formed of an adhesive composition comprising:

(A) at least one compound selected from a low density free-radical polyethylene (ldrPE); a copolymer of ethylene and a C₃-C₈ olefinic monomer (linear PE); an ethylene/propylene copolymer (EPM); an ethylene/propylene/diene (EPDM); an ethylene/vinyl acetate copolymer (EVA); a copolymer of ethylene and an acrylic derivative (EAD); a styrene/ethylene-butylene/styrene copolymer (SEBS); a styrene/butadiene/styrene copolymer (SBS); a styrene/isoprene/styrene copolymer (SIS); an ethylene/styrene copolymer (ES); a tackifying resin; and mixtures thereof; and

(B) a block copolymer containing at least two poly(monovinylic aromatic hydrocarbon) blocks and at least one hydrogenated poly(conjugated diene) block; and/or a polybut-1 -ene.

The adhesive composition according to the invention comprises a mixture of constituents (A) and (B) in any proportions. The general practice is to use from 5 to 95% by weight, preferably from 10 to 80% by weight, of constituent (B).

In terms of the present invention, the adhesive composition comprising a mixture of constituents (A) and (B) covers all the combinations of the different components of constituent (A), by themselves or in a mixture, with the different components of constituent (B), by themselves or in a mixture.

According to the invention, constituent (A) is at least one “polymer” selected from ldPEs, linear PEs, EVAs, EADs, EPMs, EPDMs, SEBSs, SBSs, SISs and ESs; a tackifying resin; or a mixture of these compounds. In terms of the present invention, “mixture of these compounds” is to be understood as meaning a mixture, in any proportions, of several polymers of the same type or a mixture of one or more polymers of a first type with one or more polymers of one or more other types, if appropriate with one or more tackifying resins.

A preferred adhesive composition is one in which constituent (A) is a linear PE, an EVA, an EAD, a tackifying resin or a mixture of these compounds, said mixture being as defined above.

Another preferred adhesive composition is one in which constituent (B) comprises polybut-1-ene or a mixture of polybut-1-ene and a block copolymer containing at least two poly(monovinylic aromatic hydrocarbon) blocks and at least one hydrogenated poly(conjugated diene) block.

An adhesive composition comprising:

(A) at least one compound selected from a low density free-radical polyethylene; a copolymer of ethylene and a C₃-C₈ olefinic monomer; an ethylene/propylene copolymer; an ethylene/propylene/diene; an ethylene/vinyl acetate copolymer; a copolymer of ethylene and an acrylic derivative; a styrene/ethylene-butylene/styrene copolymer; a styrene/butadiene/styrene copolymer; a styrene/isoprene/styrene copolymer; an ethylene/styrene copolymer; and mixtures thereof; and

(B) a block copolymer containing at least two poly(monovinylic aromatic hydrocarbon) blocks and at least one hydrogenated poly(conjugated diene) block, is also preferred.

The ldrPEs which can be used within the framework of the present invention have a density ranging from 0.915 to 0.925, as measured according to standard ASTM D 1505, and a melt flow index ranging from 0.1 to 40 dg/min, preferably ranging from 0.1 to 10 dg/min, as measured according to standard ASTM 1238. An example which may be mentioned is the product marketed under the name Lupolen200 2420F (Basell).

The linear PEs are copolymers of ethylene and a C₃-C₈ olefinic monomer such as propene, butene, hexene, methylpentene or octene (hereafter called a “co-monomer”). These linear PEs can be obtained for example by catalysis of the Ziegler-Natta type or metallocene type. It is advantageous to use low or very low density linear PEs, i.e. those with a density ranging from 0.860 to 0.936, as measured according to standard ASTM D 1505, and with a melt flow index ranging from 0.1 to 40 dg/min, preferably ranging from 0.1 to 10 dg/min, as measured according to standard ASTM 1238; these linear PEs preferably have a co-monomer content of at most 30% by weight. Examples which may be mentioned are the products marketed under the names Engage® (DuPont Dow Elastomers), Affinity® (Dow), Exact® (Dex Plastomer), Stamylan® (DSM) and Attane® (Dow).

According to the invention, the EVAs have a vinyl acetate (VA) content of at most 80% by weight, preferably of at most 40% by weight. These EVAs advantageously have a melt flow index ranging from 0.1 to 40 dg/min, preferably ranging from 0.1 to 10 dg/min, as measured according to standard ASTM 1238. Examples which may be mentioned are the products marketed under the names Levapren® (Bayer) and Greenflex® (Polimeri Europa).

The EADs preferably have a content of acrylic derivative, for example butyl acrylate and/or (meth)acrylic acid, of at most 40% by weight. These EADs advantageously have a melt flow index ranging from 0.1 to 40 dg/min, preferably ranging from 0.1 to 10 dg/min, as measured according to standard ASTM 1238. An example which may be mentioned is the product marketed under the name Lotryl® (Elf Atochem).

The EPMs preferably have a density ranging from 0.84 to 0.90, as measured according to standard ASTM D 1505, and advantageously have a propylene content ranging from 25 to 60% by weight. An example which may be mentioned is the product marketed under the name Adflex® (Basell).

The EPDMs preferably have a density ranging from 0.86 to 0.90, as measured according to standard ASTM D 1505. They advantageously have a propylene content ranging from 25 to 60% by weight and a content of diene, such as 1,4-hexadiene or ethylidenenorbornene, of at most 6% by weight. An example which may be mentioned is the product marketed under the name Nordel® (Dupont Dow Elastomers).

The SEBSs, SBSs and SISs advantageously have a styrene content of at most 50% by weight, preferably ranging from 5 to 45% by weight and particularly preferably ranging from 10 to 25% by weight; again advantageously, these polymers have a content of SEB, SB or SI diblocks of at most 70% by weight, preferably of at most 30% by weight. An example of an SBS which may be mentioned is the product marketed under the name Kraton® D1118X (Kraton Polymers). An example of an SIS which may be mentioned is the product marketed under the name Vector® 4114 (Exxon). An example of an SEBS which may be mentioned is the product marketed under the name Kraton® G1657 (Kraton Polymers).

The ESs advantageously have a styrene content ranging from 5 to 85% by weight and preferably have a melt flow index ranging from 0.1 to 40 dg/min, preferably ranging from 0.1 to 10 dg/min, as measured according to standard ASTM 1238. An example which may be mentioned is the product marketed under the name Interpolymer® index (Dow).

The tackifying resins used within the framework of the invention are well known to those skilled in the art and can be selected especially from rosin resins, terpene/phenol resins and resins obtained from C₅, (C₅)₂ and/or C₉ petroleum fractions, which can then be partially or totally hydrogenated. These resins advantageously have a softening point of at most 140° C., generally ranging from 75 to 140° C. and preferably ranging from 75 to 125° C., as measured by the ring and ball method (standard ASTM E 28). Examples which may be mentioned are the products marketed under the names Escorez® (Exxon), Sylvares® (Arizona) and Permalyn® (Hercules).

Constituent (B) of the adhesive composition according to the invention is a block copolymer containing at least two poly(monovinylic aromatic hydrocarbon) blocks and at least one hydrogenated poly(conjugated diene) block, a polybut-1-ene, or a mixture of polybut-1-ene and said block copolymer.

According to the invention, constituent (B) also comprises mixtures, in any proportions, of several polymers of the same type or mixtures of one or more polymers of the first type with one or more polymers of the other type.

The block copolymer can be linear or radial and of the type comprising linear triblock copolymers (ABA), multi-arm block copolymers ((AB)ₙX) and asymmetrical block copolymers such as ((AB)ₙX(B′)ₘ), in which A is a block of vinylic aromatic hydrocarbon polymer; B and B′ are a block of hydrogenated conjugated diene polymer; n is an integer equal to at least 2, preferably ranging from 2 to 6; m is an integer equal to at least one, preferably ranging from 1 to 4; and X is the residue of a coupling agent. The block copolymer can contain up to 40% by weight, preferably up to 30% by weight and particularly preferably up to 25% by weight of an AB diblock copolymer. If present, this diblock copolymer generally represents at least 5% by weight, preferably at least 10% by weight, of the block copolymer. The apparent molecular weight of the AB diblock copolymer, if present, typically ranges from 40,000 to 27,0000.

In the block copolymer, at least 80%, preferably at least 90% and particularly preferably at least 95% of the double bonds of the conjugated diene block(s) are hydrogenated.

The monovinylic aromatic monomer is typically selected from styrene, a (C₁-C₄)alkylstyrene and a (C₁-C₄)dialkylstyrene.

The conjugated diene monomer typically contains from 4 to 8 carbon atoms, examples being 1,3-butadiene, 2-methyl-1,3-butadiene (isoprene), 2,3-dimethyl-1,3-butadiene and mixtures thereof. The 1,2-vinyl content of a butadiene block before hydrogenation is typically at least 25% by weight, preferably ranging from 30 to 90% by weight and particularly preferably ranging from 35 to 80% by weight.

The content of monovinylic aromatic hydrocarbon in the final block copolymer is at most 50% by weight, preferably ranging from 5 to 45% by weight and particularly preferably ranging from 10 to 25% by weight, based on the weight of the block copolymer. The total apparent molecular weight of the block copolymer preferably ranges from 70,000 to 310,000.

Advantageously, the block copolymer is a styrene-based synthetic rubber, especially a block polymer of the A-B-A type, for example styrene/ethylene-butylene/styrene (SEBS) or styrene/ethylene-propylene/styrene (SEPS), SEBS being preferred. These rubbers advantageously have a styrene content as mentioned above for the monovinylic aromatic hydrocarbon and a content of SEB or SEP diblocks of at most 70% by weight, preferably of at most 30% by weight. An example of an SEBS which may be mentioned is the product marketed under the name Kraton® G1657 (Kraton Polymers).

According to the present invention, if constituent (A) is represented only by an SEBS, then constituent (B) is not represented only by a block copolymer as defined above.

The polybut-1-ene, which can be a but-1-ene homopolymer or copolymer, contains at least 80%, preferably at least 95% and particularly preferably at least 97% by weight of isotactic portions. The weight-average molecular weight typically ranges from 60,000 to 1,000,000, as determined by gel permeation chromatography.

Appropriate polybut-1-enes have a density preferably ranging from 0.875 to 0.925 and particularly preferably ranging from 0.890 to 0.920. Their melt flow index ranges from 0.05 to 400, preferably from 0.1 to 200, particularly preferably from 0.2 to 20 and very particularly preferably from 0.4 to 5 dg/min, as measured according to standard ASTM 1238.

If a but-1-ene copolymer is used, the content of co-monomer (other than but-1-ene) ranges from 1 to 50 mol %, preferably from 1 to 30 mol %. This co-monomer can be ethylene, propylene or an α-olefin having from 5 to 8 carbon atoms.

An example of a polybut-1-ene which may be mentioned is the product marketed under the name PB 0300 (Montell).

Constituent (B) can also comprise at least one compound selected from a tackifying resin as defined above for constituent (A), an aromatic resin and a plasticizer. In one advantageous embodiment of the invention, constituent (B) comprises:

100 parts by weight of block copolymer;

10 to 60 parts by weight of polybut-1-ene;

20 to 80 parts by weight of tackifying resin;

0 to 40 parts by weight of aromatic resin;

0 to 25 parts by weight of plasticizer.

The adhesive composition according to the invention can also comprise one or more additives such as stabilizers, antiblocking agents, UV inhibitors, UV barriers and plasticizers.

These additives are generally present in an amount ranging from 0.1 to 10% by weight, based on the weight of the composition.

The adhesive composition according to the invention can be prepared in conventional manner by mixing constituents (A) and (B) or alternatively by mixing the various ingredients of which each of said constituents is composed.

The support layer of the adhesive film is formed of a polyolefin-based support composition. This support layer can be of the monolayer type or of the multilayer type. Each layer advantageously comprises a free-radical polyethylene (PE); a low or very low density linear PE; polypropylene (PP); an EPM; or a mixture of these compounds. In terms of the present invention, the expression “mixture of these compounds” includes a mixture of several polymers of the same type or a mixture of one or more polymers of a first type with one or more polymers of one or more other types.

The support layer preferably comprises at least one layer consisting of a mixture of free-radical polyethylene, polypropylene and an ethylene/propylene copolymer.

The support layer advantageously has a density ranging from 0.84 to 0.960, preferably ranging from 0.900 to 0.940. It generally represents between 50 and 99% of the total thickness of the film.

The free-radical PE can equally well be low density (0.915≦d≦0.925), for example the product marketed under the name Lupolen® 2420 F (Basell); medium density (0.925≦d≦0.940), for example the product marketed under the name Lupolen® 3521 C (BASF); or high density (0.940≦d≦0.960), for example the product marketed under the name Lupolen® 3721 C (BASF).

The low or very low density linear PE and the EPM are as defined previously for constituent (A).

The PP has a density ranging from 0.890 to 0.910. Examples which may be mentioned are the products marketed under the name Moplen® (Montell).

The density of all these polymers is measured according to standard ASTM D 1505. Said polymers advantageously have a melt flow index ranging from 0.1 to 40 dg/min, preferably ranging from 0.1 to 10 dg/min, as measured according to standard ASTM 1238.

This support layer can also contain one or more additives such as caulking agents, slip agents, colorants, UV stabilizers, UV barriers, antioxidants and antiblocking agents. If the support layer is of the multilayer type, each of the layers can contain said additives.

These additives are generally present in an amount ranging from 0.1 to 25% by weight, based on the weight of the composition.

In one particular embodiment, on the other side of the support layer (i.e. on the side which is not in contact with the adhesive layer), the adhesive film according to the invention comprises a protective layer which is advantageously non-stick. Such a protective layer is well known to those skilled in the art.

The adhesive protective films according to the invention have an adhesive strength ranging from 1 to 500 cN/cm, as measured by the separating force (peeling angle=180°, peeling speed=300 mm/min, measurement at room temperature), and can be removed from the materials to which they are applied without difficulty and without leaving residues.

These adhesive films can be obtained especially by co-extrusion of the support layer and the adhesive layer. It is equally possible to employ the cast coextrusion method or the blown co-extrusion method. These methods are well known to those skilled in the art and are described for example in the work “Encyclopedia of Chemical Technology” (Kirk-Othmer), 1996, volume 19, pages 290-316. It is also possible to use the cast coating method.

Thus, according to a second feature, the invention relates to a process for the preparation of a protective film by the co-extrusion of a support layer as defined above and an adhesive layer as defined above. This process comprises the following steps:

a) the feeding of a first extruder with adhesive composition for forming the adhesive layer, and of a second extruder with support composition for forming the support layer;

b) the melting of the adhesive composition and the support composition and the conveying of the substantially molten compositions simultaneously through a die communicating with each of the extruders; and

c) the co-extrusion of a film comprising the adhesive layer and the support layer.

If the support layer is of the multilayer type, it is easy to understand that the number of extruders to be used in step a) should be the same as the number of layers constituting said support layer.

Advantageously, the resulting films have a thickness greater than 10 μm, preferably ranging from 15 to 90 μm.

According to a third feature, the invention relates to articles protected by the above-mentioned films.

The invention is illustrated by the Examples below, which are given purely by way of indication. The three-layer co-extrusion equipment used in Examples 1-3 and 5 is of the “Contracool” type marketed by Battenfeld, with an “Autoprofil” thickness regulating system; the equipment used in Example 4 is marketed by Windmöller and Hölscher.

The following temperature ranges are used in each of the extruders:

extruder no. 1: 140-220° C.

extruder no. 2: 140-220° C.

extruder no. 3: 110-220° C.

### EXAMPLE 1

An adhesive composition is prepared by mixing 10% by weight of the composition available under the name Kraton® MD 6649 (Kraton Polymers) and 90% by weight of a linear polyethylene with a density of 0.902 and an octene co-monomer content of 12% by weight.

Using three-layer co-extrusion equipment with 3 extruders, a free-radical polyethylene with a density of 0.924 and a melt flow index of 0.7 is introduced into extruder no. 1, a 90/10 by weight mixture of free-radical polyethylene with a density of 0.924 and a melt flow index of 0.7 and a linear polyethylene (butene co-monomer) with a density of 0.925 and a melt flow index of 0.7 is introduced into extruder no. 2, and the adhesive composition prepared above is introduced into extruder no. 3.

Blown co-extrusion under the normal conditions known to those skilled in the art produced an adhesive film with a thickness of 70 μm.

Applied to a PVC or PMMA sheet, this film has an adhesive strength of 10 to 200 cN/cm (depending on the gloss of the PVC or PMMA), as measured by the separating force (peeling angle=180°, peeling speed=300 mm/min, measurement at room temperature), before thermoforming of the sheet. This value does not increase after thermoforming.

### EXAMPLE 2

An adhesive composition is prepared by mixing 45% by weight of the composition available under the name Kraton® MD 6649 (Kraton Polymers) and 55% by weight of a linear polyethylene with a density of 0.912 and a melt flow index of 3.3.

Using three-layer co-extrusion equipment with 3 extruders, a free-radical polyethylene with a density of 0.924 and a melt flow index of 0.7 is introduced into extruder no. 1, a 70/27/1.5/1.5 by weight mixture of a free-radical polyethylene with a density of 0.924 and a melt flow index of 0.7, a free-radical polyethylene with a density of 0.935 and a melt flow index of 0.8, a UV inhibitor and a UV barrier is introduced into extruder no. 2, and the adhesive composition prepared above is introduced into extruder no. 3.

Blown co-extrusion under the normal conditions known to those skilled in the art produced an adhesive film with a thickness of 35 μm.

Applied to a prelacquered metal sheet (polyester lacquer with a gloss of 50), this film has an adhesive strength of 150 to 200 cN/cm, as measured by the separating force (peeling angle=180°, peeling speed=300 mm/min, measurement at room temperature).

This value does not increase significantly during temperature ageing operations.

### EXAMPLE 3

An adhesive composition is prepared by mixing 10% by weight of a linear polyethylene with a density of 0.902 and a melt flow index of 1, 45% by weight of SEBS (containing 13% by weight of styrene and 35% by weight of diblocks) and 45% by weight of a 50/50 by weight mixture of SEBS (as defined above) and a tackifying resin (with a softening point of 120° C.).

Using three-layer co-extrusion equipment with 3 extruders, a free-radical polyethylene with a density of 0.924 and a melt flow index of 0.7 is introduced into extruder no. 1, an 80/10/10 by weight mixture of a polypropylene with a density of 0.90, a linear polyethylene (butene co-monomer) with a density of 0.925 and a melt flow index of 0.7 and a white masterbatch is introduced into extruder no. 2, and the adhesive composition prepared above is introduced into extruder no. 3.

Blown co-extrusion under the normal conditions known to those skilled in the art produced an adhesive film with a thickness of 60 μm.

Applied to a sample of automotive bodywork, this film has an adhesive strength of 200 to 300 cN/cm, as measured by the separating force (peeling angle=180°, peeling speed=300 mm/min, measurement at room temperature). After a representative test over one hour at 70° C., followed by deprotection, the automotive finish is not marked at all by the adhesive.

### EXAMPLE 4

An adhesive composition is prepared by mixing 25% by weight of the composition available under the name Kraton® MD 6649 (Kraton Polymers) and 75% by weight of a linear polyethylene with a density of 0.902, a melt flow index of 1 and an octene co-monomer content of 12% by weight.

Using three-layer co-extrusion equipment with 3 extruders, a free-radical polyethylene with a density of 0.924 and a melt flow index of 0.7 is introduced into extruders no. 1 and 2, and the adhesive composition prepared above is introduced into extruder no. 3.

Blown co-extrusion under the normal conditions known to those skilled in the art produced an adhesive film with a thickness of 50 μm.

Applied to a stainless steel sheet, this film has an adhesive strength of 50 to 250 cN/cm, as measured by the separating force (peeling angle=180°, peeling speed=300 mm/min, measurement at room temperature), and has a very easy peel zipping behavior. Furthermore, this film does not separate rapidly after a deep drawing operation.

### EXAMPLE 5

An adhesive composition is prepared by mixing 8% by weight of the composition available under the name Kraton® MD 6649 (Kraton Polymers) and 92% by weight of a linear polyethylene with a density of 0.902, a melt flow index of 1 and an octene co-monomer content of 12% by weight.

Using three-layer co-extrusion equipment with 3 extruders, a free-radical polyethylene with a density of 0.924 and a melt flow index of 0.7 is introduced into extruders no. 1 and 2, and the adhesive composition prepared above is introduced into extruder no. 3.

Blown co-extrusion under the normal conditions known to those skilled in the art produced an adhesive film with a thickness of 50 μm.

Applied to a glossy aluminum sheet, this film has an adhesive strength of 50 to 150 cN/cm, as measured by the separating force (peeling angle=180°, peeling speed=300 mm/min, measurement at room temperature), and has a very easy peel zipping behavior. This film does not mark the aluminum after a drawing operation.

What is claimed is:

1. A protective adhesive film comprising a support layer and an adhesive layer, wherein the adhesive layer is formed of an adhesive composition essentially consisting of:
(A) at least one compound selected from the group consisting of a low density free-radical polyethylene; a copolymer of ethylene and a C₃-C₈ olefinic monomer; an ethylene/propylene copolymer; an ethylene/propylene/diene; an ethylene/vinyl acetate copolymer; a copolymer of ethylene and an acrylic derivative; a styrene/ethylene-butylene/styrene copolymer; a styrene/butadiene/styrene copolymer; a styrene/isoprene/styrene copolymer; an ethylene/styrene copolymer; a tackifying resin; and mixtures thereof; and
(B) polybut-1-ene or a mixture of polybut-1-ene and a block copolymer containing at least two poly(monovinylic aromatic hydrocarbon) blocks and at least one hydrogenated poly(conjugated diene) block.

2. A protective adhesive film comprising a support layer and an adhesive layer, wherein the adhesive layer is formed of an adhesive composition essentially consisting of:
(A) at least one compound selected from the group consisting of a low density free-radical polyethylene; a copolymer of ethylene and a C₃-C₈ olefinic monomer; an ethylene/propylene copolymer; an ethylene/propylene/diene; an ethylene/vinyl acetate copolymer; a copolymer of ethylene and an acrylic derivative; a styrene/ethylenebutylene/styrene copolymer; a styrene/butadiene/styrene copolymer; a styrene/isoprene/styrene copolymer; an ethylene/styrene copolymer; and mixtures thereof, and
(B) a block copolymer containing at least two poly(monovinylic aromatic hydrocarbon) blocks and at least one hydrogenated poly(conjugated diene) block.

3. The protective adhesive film according to claim 1 in which the free radical polyethylene of constituent (A) has a density ranging from 0.915 to 0.925 and preferably has a melt flow index ranging from 0.1 to 40 dg/min, preferably ranging from 0.1 to 10 dg/min.

4. The protective adhesive film according to claim 1 in which the
copolymer of ethylene and a C₃-C₈ olefinic monomer of constituent (A) has a comonomer content below 30% by weight and preferably has a melt flow index ranging from 0.1 to 40 dg/min, preferably ranging from 0.1 to 10 dg/min, said comonomer preferably being selected from propene, butene, hexene, methylpentene and octene.

5. The protective adhesive film according to claim 1 in which the ethylene/vinyl acetate copolymer of constituent (A) has a vinyl acetate content of at most 80% by weight, preferably of at most 40%, and advantageously has a melt flow index ranging from 0.1 to 40 dg/min, preferably from 0.1 to 10 dg/min.

6. The protective adhesive film according to claim 1 in which the copolymer of ethylene and an acrylic derivative of constituent (A) has an acrylic derivative content of at most 40% by weight and advantageously has a melt flow index ranging from 0.1 to 40 dg/min, preferably ranging from 0.1 to 10 dg/min.

7. The protective adhesive film according to claim 1 in which the ethylene/ propylene copolymer of constituent (A) has a density ranging from 0.84 to 0.90 and advantageously has a propylene content ranging from 25 to 60% by weight.

8. The protective adhesive film according to claim 1 in which the ethylene/ propylene/diene of constituent (A) has a density ranging from 0.86 to 0.90 and advantageously has a propylene content ranging from 25 to 60% by weight and a diene content of at most 6% by weight.

9. The protective adhesive film according to claim 1 in which the tackifying resin of constituent (A) has a softening point of at most 140° C., generally ranging from 75 to 140° C. and preferably ranging from 75 to 125° C.

10. The protective adhesive film according to claim 1 in which the styrene/ethylene-butylene/styrene copolymer, the styrene/butadiene/styrene copolymer and the styrene/isoprene/styrene copolymer of constituent (A) each have a styrene content of at most 50% by weight, preferably ranging from 5 to 45% by weight, and advantageously have a diblock content of at most 70% by weight.

11. The protective adhesive film according to claim 1 in which the ethylene/styrene copolymer of constituent (A) has a styrene content ranging from 5 to 85% by weight and advantageously has a melt flow index ranging from 0.1 to 40 dg/min, preferably ranging from 0.1 to 10 dg/min.

12. The protective adhesive film according to claim 1 in which the block copolymer of constituent (B) has a poly(monovinylic aromatic hydrocarbon) content of at most 50% by weight, preferably ranging from 5 to 45% by weight.

13. The protective adhesive film according to claim 12 in which the block copolymer is a styrene-based synthetic rubber of the A-B-A type selected from styrene/ethylene-butylene/styrene and styrene/ethylene-propylene/styrene, said rubber advantageously having a diblock content of at most 70% by weight.

14. The protective adhesive film according to claim 1 in which the polybut-1 ene of constituent (B) is a but-1-ene copolymer in which the content of comonomer other than but-1-ene ranges from 1 to 50 mol %.

15. The protective adhesive film according to claim 1 in which constituent (B) also contains at least one compound selected from a tackifying resin, an aromatic resin and a plasticizer.

16. The protective adhesive film according to claim 15 in which constituent (B) contains:
100 parts by weight of block copolymer;
10 to 60 parts by weight of polybut-1-ene;
20 to 80 parts by weight of tackifying resin;
0 to 40 parts by weight of aromatic resin; and
0 to 25 parts by weight of plasticizer.

17. The protective adhesive film according to claim 1 in which constituent (B) represents from about 5 to 95% by weight of the composition.

18. The protective adhesive film according to claim 1 in which the support layer comprises a free-radical polyethylene, a low or very low density copolymer of ethylene and a C₃-C₈ olefinic monomer, a polypropylene, an ethylene/propylene copolymer or a mixture of these compounds.

19. The protective adhesive film according to claim 1 in which the support layer is a monolayer or a multilayer.

20. A process for the preparation of the protective adhesive film as defined in claim 1 by co-extrusion of the support layer and the adhesive layer, said process comprising the steps of:
a) feeding a first extruder with adhesive composition for forming the adhesive layer, and a second extruder with support composition for forming the support layer;
b) melting the adhesive composition and the support composition and conveying the substantially molten compositions simultaneously through a die communicating with each of the extruders; and
c) co-extruding a film comprising the adhesive layer and the support layer.

21. An article coated with a protective adhesive film as defined in claim 1.
